(19) United States
(12) Patent Application Publication
(10) Pub. No.: US 2006/0047053 A1
(43) Pub. Date: Mar. 2, 2006

(54) Thermoconductive composition for RF shielding

(76) Inventors: Ivan Pawlenko, Holland, PA (US); Larry Samson, Langhorne, PA (US)

Correspondence Address: HARNESS, DICKEY & PIERCE, P.L.C., P.O. Box 8910, Reston, VA, 20195, US

(21) Appl. No.: 10/927,039

(22) Filed: Aug. 27, 2004

(51) Int. Cl. B32B 15/04; B32B 5/16; C08K 3/04

(52) U.S. Cl. 524/495; 428/323; 428/457

(57) ABSTRACT

A thermally conductive polymer composition is applied to mounted components to provide both thermal control and RF radiation attenuation. In order to improve the RF attenuation performance, a plurality of discrete conductive elements may be incorporated into the polymer composition, with the sizing, spacing and configuration of the suppressed most efficiently by the particular composition. The discrete conductive elements are significantly larger, on the order of 1-5 mils (approximately 25-127 μm) than the filler materials utilized to render the base polymer conductive. Also disclosed is an apparatus and a method for preparing and applying such a polymer composition to an electronic component.

### BACKGROUND OF THE INVENTION

The present invention relates generally to a composition incorporating conductive elements to provide RF and/or EMI shielding for electronic components and a method and apparatus for applying one or more such compositions during the fabrication of electronic devices. More specifically, the present invention relates to a method of producing a flowable composition including a base polymer composition and at least one filler material to produce a composition that reflects or attenuates radio frequency (RF) and/or electromagnetic interference (EMI). The composition may also include other filler materials for improving the thermal conductivity of the composition for increasing the conduction of heat away from the protected electronic component or device.

Printed circuit boards (PCBs) are widely used as mounting substrates in the electronics and telecommunications industry. PCBs generally include one or more layers of an insulating substrate (e.g., polymer) on which one or more conductive patterns are formed using thin layers of a conductor (e.g., copper). Various electronic components (e.g., integrated circuits, resistors, capacitors) may then be attached to the conductive patterns to form a desired electrical circuit. Many of these electrical circuits include components which emit high radio frequencies (RF) that can interfere with the operation of other nearby components or circuits. Thus, it is frequently desirable to use shielding to reduce the emissions from the radiating components and/or the reduce the exposure of the sensitive components to prevent or suppress RF interference and thereby improve the operation of the circuit.

For compact electronic devices, such as cell phones, an incorporated PCB may be utilized as a part of a shielding system by providing a grounding connection for a conductive housing (often referred to as a “shield can”) or fence that completely or partially surrounds one or more of the electronic components mounted on the PCB. Particularly in space-limited applications, the conventional shield cans may assume somewhat complex configurations. As a result, providing RF protection for a range of electronic components typically requires maintaining a large number of specific dedicated conductive housings or compromising performance through the use of more generic conductive housings that may be used with a wider variety of components, thereby reducing the number of parts in inventory. The use of shield cans also introduces manufacturing complexity with the need to maintain sufficient inventory and programming and/or configuring fabrication equipment to install such shields on PCBs or other substrates.

There are two main techniques for reducing the radiation from an emitting device or component system and/or for improving the resistance of a sensitive device or component to radiation. One technique addresses the PCB level issues by incorporating various design techniques, for example device spacing and board level shields. The second technique places one or more devices or components in a shielded enclosure, such as a conductive gasket. Appropriate shielding provided on a PCB can reduce internal crosstalk and circuit path coupling. In many instances, however, the most cost effective approach will utilize a combination of the two techniques with both a PCB design that reduces radiation and/or radiation sensitivity and shielding of at least some of the individual components mounted on the PCB.

As mentioned above, a shield can is one embodiment of a board level shield (BLS). It is typically configured as a five-sided enclosure or an open four-sided enclosure that can be closed with a removable top and formed from tin-plated steel or other conductive material with the sixth side of the “box” being formed by the ground plane of the PCB. The shield cans may then be positioned, and typically soldered in place, around a component or circuit on the PCB to provide a conductive barrier between a radiation source and a radiation receptor to suppress or attenuate the amount of electromagnetic energy propagating from the source to the receptor so that it remains within the design tolerance of the components involved.

In addition to RF emissions, many of the electronic components typically mounted on PCBs also generate heat, sometimes significant quantities of heat, during operation that should be removed from the component, and/or adjacent components, to improve both performance and system operating life. Compact configurations with closely spaced components can complicate the ability to remove sufficient heat from the various types of electronic components. Integrated circuit devices, particularly main processor chips, tend to generate a great deal of heat that must be removed to avoid degrading the operation of the system.

A number of methods have been utilized for cooling heat generating components. Generally, a combination of conductive and convective heat transfer is used. Because space adjacent the board is generally limited, the heat will typically be conducted to one or more heat sinks or thermal bodies arranged near the periphery of the PCB to provide for convective cooling. For example, in certain applications heat pipes incorporating a working fluid may be used for transferring heat from internal regions of an apparatus to peripheral regions where natural and/or forced convection using one or more fans may be utilized to expel heat to the surrounding environment. The heat sinks and/or thermal bodies may also be provided with fins, blades, pins or other structures that tend to increase the heat transfer area and the convective heat transfer. Although forced convection can improve heat dissipation, the fans and blowers utilized consume additional power, are themselves subject to failure and are much less reliable than passive cooling devices.

In heat transfer applications, it is well known to utilize materials having high thermal conductivity, such as metals, to dissipate heat from integrated circuit device packages. For shielding applications in which a shield housing can also be used as a heat sink, the metallic material may be cast, built, tooled or machined from bulk metals into the desired configuration. Such metallic conductive articles are, however, typically heavy, costly to manufacture and susceptible to corrosion. Further, indiscriminate use of metallic structures may actually exacerbate electromagnetic interference (EMI) issues and degrade the performance of the heat-generating device or nearby components. Further, the range of configurations for the machined articles are limited by the process capability of the fabrication equipment.

Shield cans may be attached to a PCB by first attaching clips or posts to the PCB with subsequent attachment of the main body of the shield can to the clips or posts. Alternatively, the shield cans may be soldered directly to the PCB. For components that generate a significant quantity of heat, spring-loaded contact elements may be provided within the shield can for establishing a heat conduction path between the component and the shield can. The spring-loaded contact element allows the conduction path to adapt to dimensional changes resulting from the thermal expansion of the components and to compensate for different coefficients of thermal expansion (CTE). These solutions still present a variety of potential processing challenges associated with the need for accurate positioning and alignment of the various components during the assembly process. For example, preventing shifting during solder reflow, damage to attachment components, poor thermal contact and cracking of solder joints are just some of the potential challenges.

Conductive polymers have been utilized in order to address some of the challenges. However, polymer compositions filled with metallic reinforcing materials, such as copper flakes, tend to absorb EMI and RF radiation. As a result, these materials effectively become antennas that absorb EMI and RF radiation that could interfere with the operation of the device incorporated within the conductive polymer. Conversely, efforts to provide an insulating encapsulate in order to reduce or avoid EMI and RF absorption would also tend to reduce thermal conductivity and would be less able to transfer heat away from the component.

In view of the foregoing, there exists a demand for a more easily manufactured, thermally conductive EMI and RF shield that supports passive and/or active heat dissipation and is readily adaptable and suitable for a wide range of device geometries.

### SUMMARY OF THE INVENTION

The present invention utilizes a thermoconductive polymeric composition incorporating conductive particles such as metalized spheres, fibers or other particles within the polymeric composition, in which the size and density of the conductive particles improve the RF and/or EMI shielding performance of the polymeric composition. The present invention also provides an exemplary method and apparatus for forming and applying the thermoconductive polymeric composition to board level components and allows for integration of the thermoconductive polymer with other shielding structures to improve overall performance.

As disclosed herein, an exemplary method of shielding an electronic component according to the present invention will typically involve mounting an electronic component on a substrate, such as a PCB, and encapsulating the electronic component in a shielding polymer, the shielding polymer including conductive particles, the particles being of sufficient size and number to provide radio frequency (RF) shielding of the electronic component. Additional process steps such as preparing a thermoconductive polymer as the base polymer, mixing conductive particles into the base polymer to form a shielding polymer; applying the shielding polymer to exposed surfaces of the electronic component; and solidifying the shielding polymer. The conductive particles may be selected from a group consisting of metalized balls, conductive balls, carbon black, carbon fibers, carbon nanotubes and metalized carbon nanotubes, with the density and sizing being a function of the anticipated RF frequencies that the shielding polymer is intended to attenuate.

The mixing of the conductive particles and the base polymer may be accomplished using any conventional mixing or blending equipment suitable for the desired volume and viscosity of the shielding polymer that is required for the coating operation. Examples of such mixing devices include mixing tubes and screw extruders. The conductive particles can be introduced into the base polymer as a dry powder or may be prepared as an admixture with one or more solvents, dispersants or other compounds intended to improve the mixing and distribution of the particles within the base polymer. The mixing or blending equipment will typically terminate in, or feed into, a distribution head that will apply a predetermined volume of the shielding polymer to the component to encapsulate, at least partially, the component.

Once the shielding polymer has been applied to the component, it may be solidified by one or more mechanisms including polymerization, with or without a catalyst, dehydration, UV-curing and heating. Depending on the demands of the particular application, additional materials may be applied to the component to form a multi-layer encapsulating structure. In addition to the primary shielding polymer, the additional materials may include one or more of a modified shield can or fence, a metalized fabric, an additional shielding polymer layer, a strain relief layer, an external conductive layer for improving EMI performance and a dielectric layer. Where more than one shielding polymer layer is utilized, the shielding layers may incorporate different base polymers and/or different combinations of the particulate and performance additives for “tuning” the performance of the final shielding enclosure.

An electronic component shielded according to an exemplary embodiment of this invention will include a layer of a thermoconductive polymer encapsulating a majority of the surface of the electronic component with conductive particles distributed throughout the thermoconductive polymer, the particles being of sufficient size and number to provide RF shielding of the electronic component. The shielded electronic component may also include a layer of a dielectric material formed between the electronic component and the layer of thermoconductive polymer or a more conductive polymer formed below or over the thermoconductive polymer.

When more than one coating or encapsulating composition is used, it is preferred that their coefficients of thermal expansion (CTE) be suitably matched to avoid inducing mechanical strain as the component and its encapsulating layers heat up during operation of the device. The shielded component may also incorporate a metal assembly in addition to the thermoconductive polymer. The metal assembly may be generally continuous or may be provided with slots, perforations or other openings. The metal assembly may be applied to the component before application of the shielding polymer so that the metal assembly is encapsulated within or covered by the shielding polymer. Alternatively, the metal assembly may be applied to the component subsequent to the application of the shielding polymer, with the shielding polymer acting as an adhesive for securing the metal assembly and eliminating the need for separate clips and/or posts.

An exemplary apparatus for manufacturing and applying the shielding polymer according to the invention will typically include at least a thermoconductive polymer supply, a conductive particle supply, a mixing chamber into which thermoconductive polymer and conductive particles may be introduced to produce a shielding polymer and a dispenser arranged to receive shielding polymer and dispense predetermined quantities of the shielding polymer onto an electronic component. An exemplary apparatus will also typically include a conveyor for moving the electronic component past the dispenser and/or a mechanism for moving the dispenser relative to the component during application of the shielding polymer. An exemplary apparatus may also include optical or other alignment devices to ensure that the dispenser and component are properly aligned before and during the dispensing operation.

It can be appreciated that the present application has a broad range of applications in areas where use of lightweight material is needed to transfer heat out of an object while reflecting EMI and suppressing propagation of RF radiation. It is, therefore, a desire of the present invention to provide a thermally conductive composite material that: suppresses at least RF, and preferably EMI, radiation; may be applied to a wide variety of components; and exhibits controllable coating characteristics.

### BRIEF DESCRIPTION OF THE DRAWINGS

The above and other features and advantages of the present invention will become more apparent by describing in detail exemplary embodiments thereof with reference to the attached drawings in which:

FIG. 1A illustrates a first embodiment of a component having a shielding layer according to the present invention with FIG. 1B illustrating a cross-sectional view of the component illustrated in FIG. 1A taken along line B-B;

FIG. 2A illustrates a second embodiment of a component having a shielding layer according to the present invention with FIG. 2B illustrating a cross-sectional view of the component illustrated in FIG. 2A taken along line B-B;

FIG. 3 illustrates an exemplary apparatus for fabricating a shielded component according to the present invention; and

FIGS. 4A-C illustrate exemplary embodiments of the invention that incorporate a metal assembly.

These drawings have been provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity. Those of ordinary skill in the art will also appreciate that a range of alternative configurations have been omitted simply to improve the clarity and reduce the number of drawings.

### DETAILED DESCRIPTION OF THE INVENTION

The present invention includes both a composition and method for forming a composition by combining a base thermoconductive polymer composition with one or more conductive materials to provide an increase in RF and/or EMI shielding performance of encapsulated electronic components.

Exemplary embodiments of the present invention utilize a base thermoconductive polymer that typically includes one or more polymer compositions in combination with one or more filler materials. The polymer composition(s) used in the base thermoconductive polymer composition may include one or more polymers that exhibit the desired combination of melting temperature, viscosity and durability. Although the polymer composition(s) tend to be poor conductors, the addition of fine conductive filler materials may dramatically improve the electrical and thermal conductivity of the thermoconductive polymer composition over that of the unmodified polymer(s). The filler loadings are commonly as high as 50-60 volume percent with the balance being the polymer(s) and other minor additives. Depending on the particular combination of polymer(s) and filler(s), the filler loading can exceed 60 volume percent on occasion.

Advantages offered by the thermoconductive polymer composition are its ability to mold to the component, thereby engaging substantially all of the exposed surface of the component for conductive heat transfer and its ability to flow and mold to even more complex geometries of the component. Similarly, by manipulating the relative movement of the dispensing head and/or the component(s) and the polymer discharge rate, the same thermoconductive polymer may be used for coating a wide variety of components.

Particularly with the addition of conductive particles having an average maximum dimension on the order of 1-5 mils (approximately 25.4-127 μm) the exemplary thermoconductive polymers will also provide improved RF shielding. As will be appreciated by those of ordinary skill in the shielding art, the number, size, spacing and configuration of the conductive particles incorporated in the thermoconductive polymer will affect the shielding performance, particularly with regard to the frequency range that is most successfully attenuated by a particular combination of polymer(s), fillers and conductive particles. As a result of this versatility, the thermoconductive polymer compositions according to the present invention may be useful in a wide range of applications that call for a combination of insulation, conductivity and shielding properties. For example, the use of conductive fibers such as metalized carbon nanotubes, whether singly or in combination with spherical or other configurations of conductive particles may improve the shielding performance of the shielding layer.

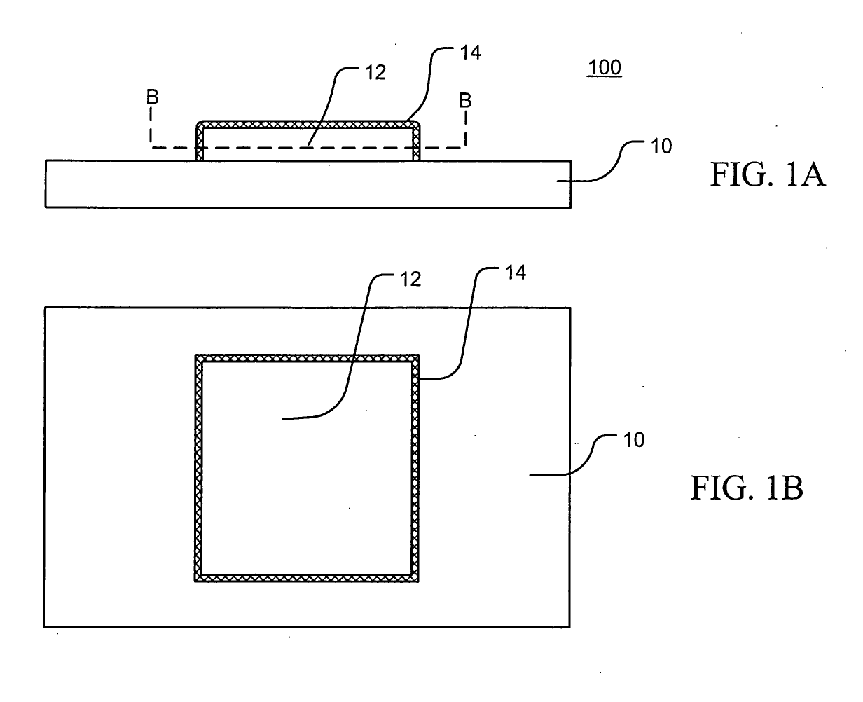

As illustrated in FIGS. 1A-B, an exemplary embodiment of the invention 100 includes a substrate 10 on which a component 12 is mounted, typically by soldering component leads, solder balls or conductive bumps to corresponding connection regions or structures provided on the substrate. The component 10 is then encapsulated with a at least a partial layer of a thermoconductive polymer 14 according to the present invention. The thermoconductive polymer will typically incorporate a plurality of small, preferably on the order of several mils (about 50-100 μm), conductive particles sufficient to impart some RF resistance to the component.

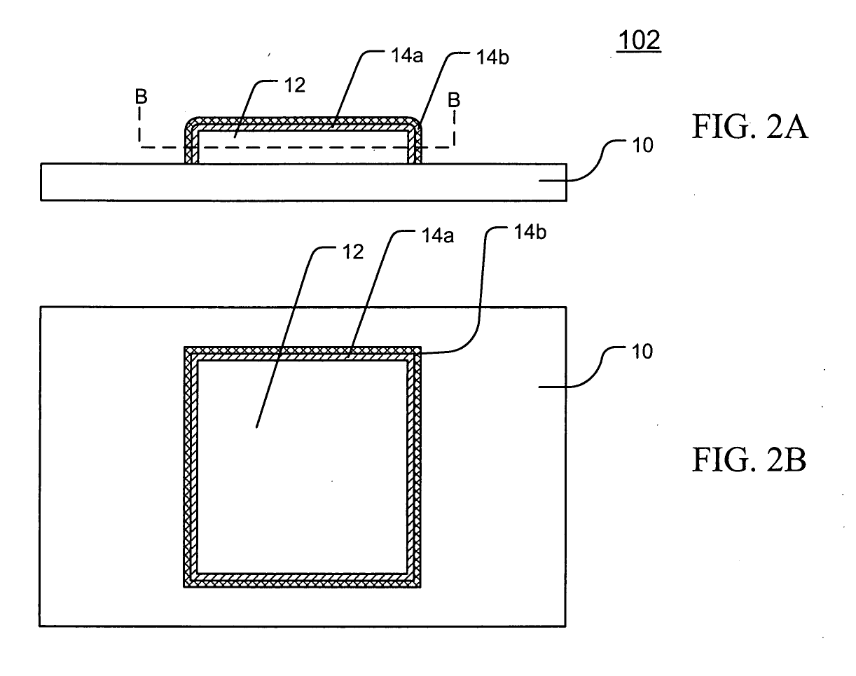

As illustrated in FIGS. 2A-2B, another exemplary embodiment of the invention 102 includes two encapsulating layers, 14a, 14b, that allow the performance of the encapsulation to be “tuned” by selecting the sequence and properties of the two or more layers that make up the encapsulating structure. In addition to the primary thermoconductive shielding polymer, additional layers may include one or more of an additional shielding polymer layer, a strain relief layer, an external conductive layer for improving EMI performance and a dielectric layer. Where more than one shielding polymer layer is utilized, the shielding layers may incorporate different base polymers and/or different combinations or configurations of the conductive particulate(s) and other additives for “tuning” the performance of the final shielding enclosure for the intended application.

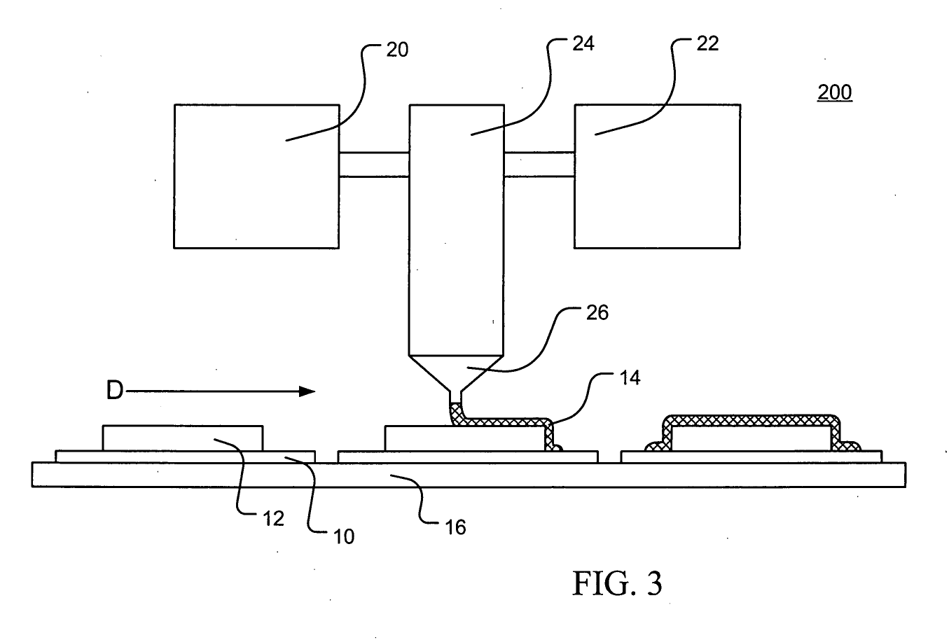

As illustrated in FIG. 3, an exemplary apparatus 200 for applying the thermoconductive polymer will include at least one polymer supply vessel 20, the polymer being maintained within the supply vessel as a liquid, powder or pellets, and a conductive particulate supply vessel 22 in which a supply of particulates is maintained, typically as either a powder or as an admixture compatible with the polymer composition. Both the polymer supply vessel 20 and the conductive particulate supply vessel 22 are arranged to feed, typically at one or more user selectable rates, their respective contents into a mixing vessel 24.

The mixing vessel 24 may be configured in accord with any conventional mixing apparatus having sufficient mixing capacity to prepare a substantially uniformly mixed thermoconductive polymer composition as the separate components flow through the mixing vessel. The mixing vessel 24 may terminate with or be connected to (not shown) a dispensing apparatus or head 26 from which the thermoconductive polymer composition will be applied to the component 12 to form the shielding layer 14. The apparatus 200 will also typically include a conveyor 18 for moving substrates 10 with the mounted components 12 in a direction D past the dispensing apparatus 26 to have the thermoconductive polymer applied. The dispensing apparatus 26 may also be capable of controlled movement in one or more of the x, y and z directions and may include optical or other alignment devices to ensure proper coating of the component under process.

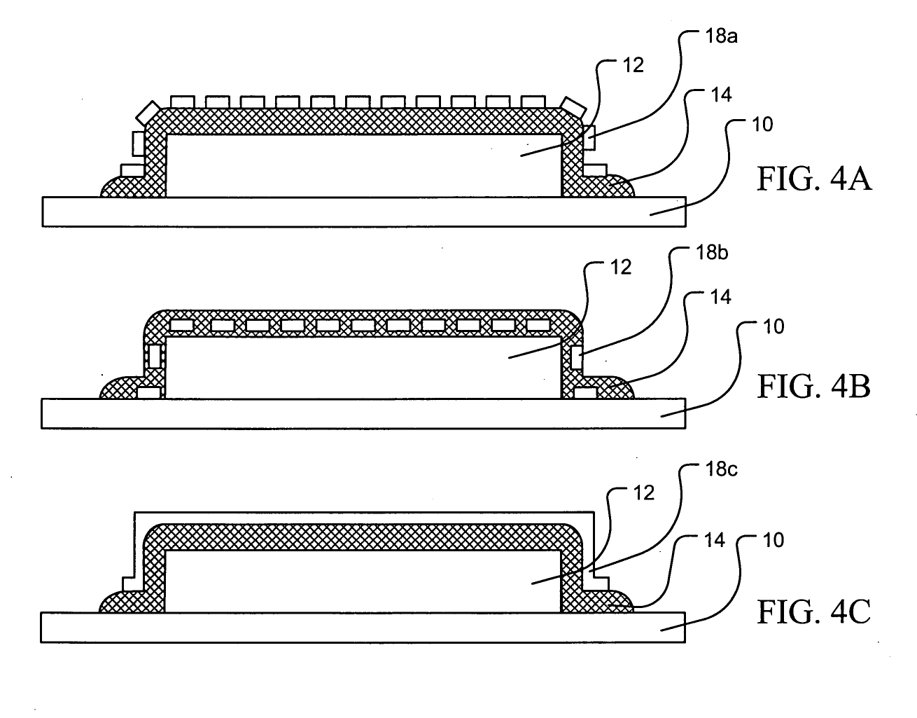

As illustrated in FIGS. 4A-C, the thermoconductive polymer 14 can be utilized in combination with a metal assembly 18a-c. As noted above, depending on the demands of the particular application, additional materials may be applied to the component to form a multi-layer encapsulating structure one or more of a modified shield can or fence, a conductive mesh or a metalized fabric. As illustrated in FIG. 4A, the shielding may incorporate a slotted or perforated metal assembly 18a that is adhered to the thermoconductive polymer layer 14, thereby avoiding the need for a separate soldering step. As illustrated in FIG. 4B, the metal assembly 18b can be incorporated within one or more (not shown) layers of thermoconductive, insulating or strain relieving polymers. And as illustrated in FIG. 4C, a substantially solid metal assembly 18c may be applied over and attached to the underlying thermoconductive layer 14. Although illustrated as a simple or perforated “can,” it will be appreciated that the metal assemblies 18a-c could also be provided with projections to increase the surface area available for convective heat transfer and/or provide a connection to a heat sink region for controlling the temperature reached by the component 12 during operation.

It would be appreciated by those skilled in the art that various changes and modifications can be made to the illustrated embodiments without departing from the spirit of the present invention. All such modifications and changes are intended to be covered by the appended claims.

We claim:

1. A thermoconductive polymer composition suitable for shielding an electronic component comprising:
a thermoconductive polymer; and
conductive particles distributed within the thermoconductive polymer, the conductive particles being of sufficient size and number to attenuate a radio frequency (RF) signal of known frequency.

2. A thermoconductive polymer composition according to claim 1, wherein:
a shielding layer formed from the thermoconductive polymer has a thickness sufficient to provide a predetermined level of attenuation of the RF signal.

3. A thermoconductive polymer composition according to claim 2, wherein:
the shielding layer thickness is sufficient to provide a predetermined level of thermal conduction.

4. A thermoconductive polymer composition according to claim 1, wherein:
the conductive particles are selected from a group consisting of metalized balls, conductive balls, carbon black, carbon fibers, carbon nanotubes and metalized carbon nanotubes.

5. A method of shielding an electronic component comprising:
mounting an electronic component on a substrate; and
encapsulating a majority of an exposed surface of the electronic component in a shielding polymer,
wherein the shielding polymer includes conductive particles of a sufficient size and number to provide radio frequency (RF) shielding of the electronic component.

6. A method of shielding an electronic component according to claim 5, wherein:
encapsulating the electronic component includes;
preparing a thermoconductive polymer,
mixing a plurality of conductive particles into the thermoconductive polymer to form a shielding polymer,
applying the shielding polymer to exposed surfaces of the electronic component, and
solidifying the shielding polymer.

7. The method of shielding an electronic component according to claim 6, wherein:
the conductive particles are selected from a group consisting of metalized balls, conductive balls, carbon black, carbon fibers, carbon nanotubes and metalized carbon nanotubes.

8. The method of shielding an electronic component according to claim 6, wherein:
the size and number of the conductive particles are sufficient to provide an average spacing sufficient to attenuate RF radiation of a known frequency range.

9. The method of shielding an electronic component according to claim 6, wherein:
mixing the plurality of conductive particles into the thermoconductive polymer includes flowing the conductive particles and the thermoconductive polymer through a mixing tube.

10. The method of shielding an electronic component according to claim 6, wherein:
mixing the plurality of conductive particles into the thermoconductive polymer includes flowing the conductive particles and the thermoconductive polymer through a screw extruder.

11. The method of shielding an electronic component according to claim 6, wherein:
mixing the plurality of conductive particles into the thermoconductive polymer includes;
forming an admixture including a suitable polymer and the conductive particles, and
blending the admixture into the thermoconductive polymer to form the shielding polymer.

12. The method of shielding an electronic component according to claim 6, wherein:
solidifying the shielding polymer includes a method selected from a group consisting of dehydration, UV-curing and thermal curing.

13. The method of shielding an electronic component according to claim 5, further comprising:
applying a dielectric layer to the electronic component before applying the shielding polymer.

14. The method of shielding an electronic component according to claim 13, wherein:
the dielectric layer has a first average thickness; and
the shielding polymer has a second average thickness, wherein a ratio of the first average thickness to the second average thickness is between about 1:1 and 1:10.

15. A radio frequency (RF) shielded electronic component comprising:
an electronic component;
a layer of a thermoconductive polymer encapsulating a majority of an exposed surface of the electronic component;
conductive particles distributed within the thermoconductive polymer, the particles being of sufficient size and number to provide RF shielding of the electronic component.

16. The RF shielded electronic component according to claim 15, further comprising:
a layer of a dielectric material formed between the electronic component and the layer of thermoconductive polymer.

17. The RF shielded electronic component according to claim 16, wherein:
the dielectric material has a first coefficient of thermal expansion (CTE); and
the thermoconductive polymer has a second CTE, wherein first CTE and the second CTE differ by no more than about 5%.

18. The RF shielded electronic component according to claim 15, further comprising:
a metal assembly having an inner surface and an outer surface, wherein substantially all of the inner surface is in direct contact with the thermoconductive polymer.

19. The RF shielded electronic component according to claim 15, further comprising:
a substrate on which the electronic component is mounted, the electronic component having a plurality of exposed surfaces, wherein the thermoconductive polymer encapsulates substantially all of the exposed surfaces of the electronic component.

20. The RF shielded electronic component according to claim 19, further comprising:
a metal assembly having an inner surface and an outer surface, wherein substantially all of the inner surface is in direct contact with the thermoconductive polymer.

21. The RF shielded electronic component according to claim 20, wherein:
the metal assembly encapsulates substantially all of the exposed surfaces of the electronic component.

22. The RF shielded electronic component according to claim 20, wherein:
the metal assembly includes a plurality of openings through which regions of the thermoconductive polymer are exposed.

23. An apparatus for applying shielding polymer to an electronic component comprising:
a thermoconductive polymer supply;
a conductive particle supply;
a mixing chamber into which thermoconductive polymer and conductive particles may be introduced to produce a shielding polymer;
a dispenser arranged to receive shielding polymer and dispense predetermined quantities of the shielding polymer onto an electronic component.

24. The apparatus for applying shielding polymer to an electronic component according to claim 23 further comprising:
a conveyor for moving the electronic component past the dispenser.

25. The apparatus for applying shielding polymer to an electronic component according to claim 24, wherein:
the electronic component is mounted on a surface of a substrate; and
a portion of the surface of the substrate adjacent the electronic component is also encapsulated.

26. The apparatus for applying shielding polymer to an electronic component according to claim 25, wherein:
the encapsulated portion of the surface of the substrate includes a portion of a heat sink region.

27. The apparatus for applying shielding polymer to an electronic component according to claim 25, wherein:
the encapsulated portion of the surface of the substrate includes a portion of a convective heat transfer element.

28. The apparatus for applying shielding polymer to an electronic component according to claim 23 further comprising:
a mechanism for applying a metal assembly to the dispensed thermoconductive polymer.

29. The apparatus for applying shielding polymer to an electronic component according to claim 23 further comprising:
a device for solidifying the dispensed thermoconductive polymer.
